(19) United States
(12) Patent Application Publication
(10) Pub. No.: US 2019/0047875 A1
(43) Pub. Date: Feb. 14, 2019

(54) SEWAGE PURIFYING APPARATUS

(71) Applicants: SHUN TSUNG LU, Taichung City (TW); TA WEI LU, Taichung City (TW)

(72) Inventor: SHUN TSUNG LU, Taichung City (TW)

(21) Appl. No.: 15/675,290

(22) Filed: Aug. 11, 2017

(51) Int. Cl. C02F 1/00

(52) U.S. Cl. CPC C02F 1/004; B01D 37/00

(57) ABSTRACT

A sewage purifying apparatus has a first pump, a coarse filter, a second pump, a first centrifugal filter, a third pump, a second centrifugal filter, a fourth pump, a secondary filter, and a storage tank. The coarse filter is connected to and communicates with the first pump. The second pump is connected to and communicates with the coarse filter. The first centrifugal filter is connected to and communicates with the second pump. The third pump is connected to and communicates with the first centrifugal filter. The second centrifugal filter is connected to and communicates with the third pump. The fourth pump is connected to and communicates with the second centrifugal filter. The secondary filter is connected to and communicates with the fourth pump and has multiple filtering elements. The storage tank is connected to and communicates with the secondary filter.

### BACKGROUND OF THE INVENTION

### 1. Field of the Invention

The present invention relates to a sewage purifying apparatus, and more particularly to a sewage purifying apparatus that may filter the sewage by several physical means of filtration and may remove impurities in the sewage to improve the filtering effect to the sewage.

### 2. Description of Related Art

Generally, the sewage is mainly produced from households, industries, agricultural and animal husbandry, medical facilities, etc. In the households, the sewage is produced from the toilets, the bathrooms, and the kitchen. At present, in the developed countries, the black water and gray water in the sewage are recycled by a separation process. After the separation process, the gray water can be used to flush the toilets or to irrigate farmlands.

A conventional sewage purifying method uses a spring filter to filter the sewage, and the spring filter has a water box and at least one spring. The at least one spring is disposed in the water box to filter the impurities in the sewage. Although the gaps of the at least one spring can be adjusted to filter the impurities of different sizes, the range of gap-adjustment of the at least one spring is limited. When the sizes of the impurities are too small such as the silt, the impurities may still pass through the at least one spring of the spring filter, and this will affect the filtering effect to the sewage.

To overcome the shortcomings, the present invention provides a sewage purifying apparatus to mitigate or obviate the aforementioned problems.

### SUMMARY OF THE INVENTION

The main objective of the present invention is to provide a sewage purifying apparatus, and more particularly to a sewage purifying apparatus that may filter the sewage by several physical means of filtration and may remove impurities in the sewage to improve the filtering effect to the sewage.

The sewage purifying apparatus in accordance with the present invention has a first pump, a coarse filter, a second pump, a first centrifugal filter, a third pump, a second centrifugal filter, a fourth pump, a secondary filter, and a storage tank. The coarse filter is connected to and communicates with the first pump. The second pump is connected to and communicates with the coarse filter. The first centrifugal filter is connected to and communicates with the second pump. The third pump is connected to and communicates with the first centrifugal filter. The second centrifugal filter is connected to and communicates with the third pump. The fourth pump is connected to and communicates with the second centrifugal filter. The secondary filter is connected to and communicates with the fourth pump and has multiple filtering elements. The storage tank is connected to and communicates with the secondary filter.

Other objectives, advantages and novel features of the invention will become more apparent from the following detailed description when taken in conjunction with the accompanying drawings.

### BRIEF DESCRIPTION OF THE DRAWINGS

FIG. 1 is a side view in partial section of a first embodiment of a sewage purifying apparatus in accordance with the present invention;

FIG. 2 is an operational side view in partial section of the sewage purifying apparatus in FIG. 1;

FIG. 3 is a side view in partial section of a second embodiment of a sewage purifying apparatus in accordance with the present invention; and

FIG. 4 is an operational side view in partial section of the sewage purifying apparatus in FIG. 3.

### DETAILED DESCRIPTION OF THE PREFERRED EMBODIMENT

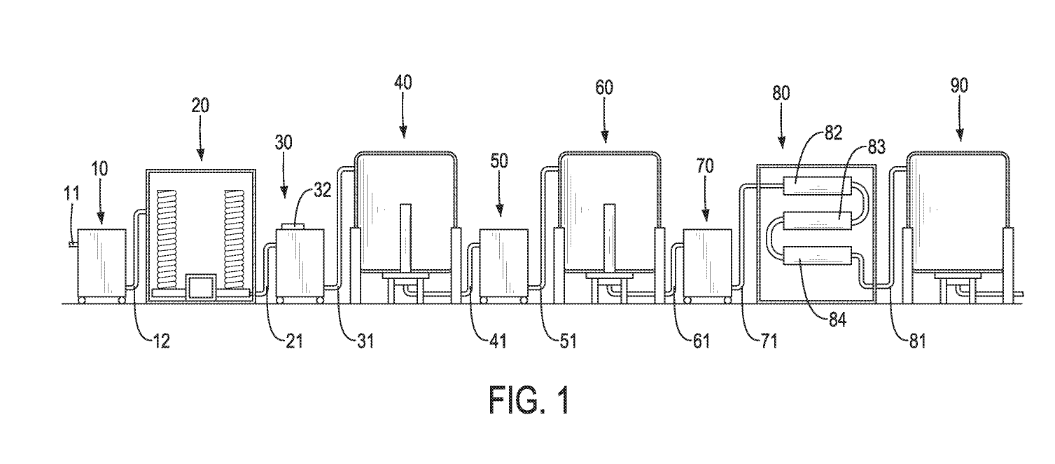

With reference to FIG. 1, a first embodiment of a sewage purifying apparatus in accordance with the present invention has a first pump 10, a coarse filter 20, a second pump 30, a first centrifugal filter 40, a third pump 50, a second centrifugal filter 60, a fourth pump 70, a secondary filter 80, and a storage tank 90.

The first pump 10 is used to draw liquid and has an inlet pipe 11 and a first outlet pipe 12. The inlet pipe 11 is disposed on the first pump 10 to draw the liquid in the first pump 10. The first outlet pipe 12 is disposed on the first pump 10 to discharge the liquid out of the first pump 10. The coarse filter 20 may be a spring filter, is connected to and communicates with the first pump 10 via the first outlet pipe 12 of the first pump 10 to filter the liquid from the first pump 10, and has a second outlet pipe 21. The second outlet pipe 21 is disposed on the coarse filter 20 opposite to the first outlet pipe 12.

The second pump 30 is connected to and communicates with the coarse filter 20 via the second outlet pipe 21, is used to draw the liquid from the coarse filter 20, and has a third outlet pipe 31 and an oxygenation device 32. The third outlet pipe 31 is disposed on the second pump 30 opposite to the second outlet pipe 21 of the coarse filter 20. The oxygenation device 32 is disposed on the second pump 30 to provide ozone into the second pump 30 to sterilize the air in the second pump 30 and to sterilize the liquid in the second pump 30 when the ozone is dissolved in the liquid.

The first centrifugal filter 40 is connected to and communicates with the second pump 30 via the third outlet pipe 31 of the second pump 30 to filter the liquid from the second pump 30 in a centrifugal manner, and has a fourth outlet pipe 41. The fourth outlet pipe 41 is disposed on the first centrifugal filter 40 opposite to the third outlet pipe 31 of the second pump 30. The third pump 50 is connected to and communicates with the first centrifugal filter 40 via the fourth outlet pipe 41, is used to draw the liquid from the first centrifugal filter 40, and has a fifth outlet pipe 51. The fifth outlet pipe 51 is disposed on the third pump 50 opposite to the fourth outlet pipe 41 of the first centrifugal filter 40.

The second centrifugal filter 60 is connected to and communicates with the third pump 50, is used to filter the liquid from the third pump 50 in a centrifugal manner, and has a sixth outlet pipe 61. The sixth outlet pipe 61 is disposed on the second centrifugal filter 60 opposite to the fifth outlet pipe 51 of the third pump 50. The fourth pump 70 is connected to and communicates with the second centrifugal filter 60 via the sixth outlet pipe 61, is used to draw the liquid from the second centrifugal filter 60, and has a seventh outlet pipe 71. The seventh outlet pipe 71 is disposed on the fourth pump 70 opposite to the sixth outlet pipe 61 of the second centrifugal filter 60. Furthermore, each one of the first pump 10, the second pump 30, the third pump 50, and the fourth pump 70 may be a gear pump.

The secondary filter 80 is connected to and communicates with the fourth pump 70 via the seventh outlet pipe 71, is used to filter the liquid from the fourth pump 70, and has an eighth outlet pipe 81, a first filtering element 82, a second filtering element 83, and a third filtering element 84. The eighth outlet pipe 81 is disposed on the secondary filter 80 opposite to the seventh outlet pipe 71 of the fourth pump 70. The first filtering element 82 may be activated carbon, is disposed in the secondary filter 80, and is connected to and communicates with the seventh outlet pipe 71 of the fourth pump 70. The second filtering element 83 may be resin, is disposed in the secondary filter 80, and is connected to and communicates with the first filtering element 82. The third filtering element 84 may be ceramics, is disposed in the secondary filter 80, and is connected to and communicates with the second filtering element 83 and the eighth outlet pipe 81. The storage tank 90 is connected to and communicates with the secondary filter 80 via the eighth outlet pipe 81 to store the liquid after filtration and sterilization.

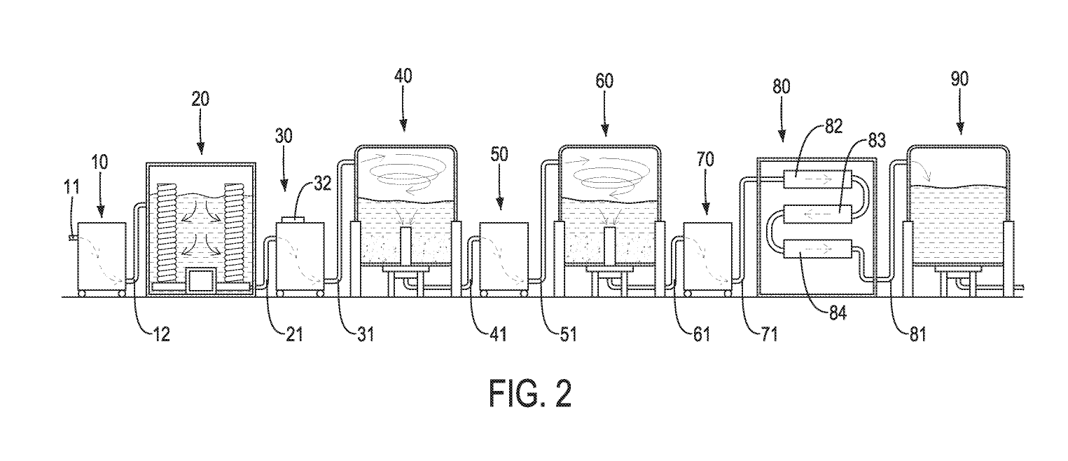

With reference to FIGS. 1 and 2, when the first embodiment of the sewage purifying apparatus of the present invention is in use, the first pump 10 draws sewage from a sewage pool via the inlet pipe 11, and the sewage flows into the coarse filter 20 via the first outlet pipe 12 of the first pump 10. Then, the coarse filter 20 is a spring filter and may filter the impurities of large size out of the sewage, and the sewage without the impurities of large size is drawn by the second pump 30 and flows into the second pump 30 via the second outlet pipe 21. The oxygenation device 32 may provide ozone to sterilize the air in the second pump 30, and may sterilize the sewage in the second pump 30 when the ozone is dissolved in the sewage.

The sewage after sterilization flows in the first centrifugal filter 40, and the impurities and water are separated by a centrifugal force of the first centrifugal filter 40, and the water (first centrifugal-filtering) in the first centrifugal filter 40 is drawn by the third pump 50 and flows in the second centrifugal filter 60 via the fourth outlet pipe 41 and the fifth outlet pipe 51. The water in the second centrifugal filter 60 is centrifuged and filtered again by a centrifugal force to improve purity of water. The water (second centrifugal-filtering) in the second centrifugal filter 60 is drawn by the fourth pump 70 and flows in the secondary filter 80 via the sixth outlet pipe 61 and the seventh outlet pipe 71. The water in the secondary filter 80 is filtered by the first filtering element 82, the second filtering element 83, and the third filtering element 84 sequentially to filter tiny particles such as sludge out of the water to obtain pure water. After the above-mentioned filtration and sterilization, the pure water is stored in the storage tank 90 via the eighth outlet pipe 81.

According to the features and structural relationship of the sewage purifying apparatus, the sewage purifying apparatus of the present invention can be used to filter the impurities of different sizes in the sewage by several physical means of filtration of the coarse filter 20, the centrifugal filters 40, 60, and the secondary filter 80, and the impurities and tiny particles can be filtered out of the sewage to obtain the pure water to improve the filtering effect to the sewage.

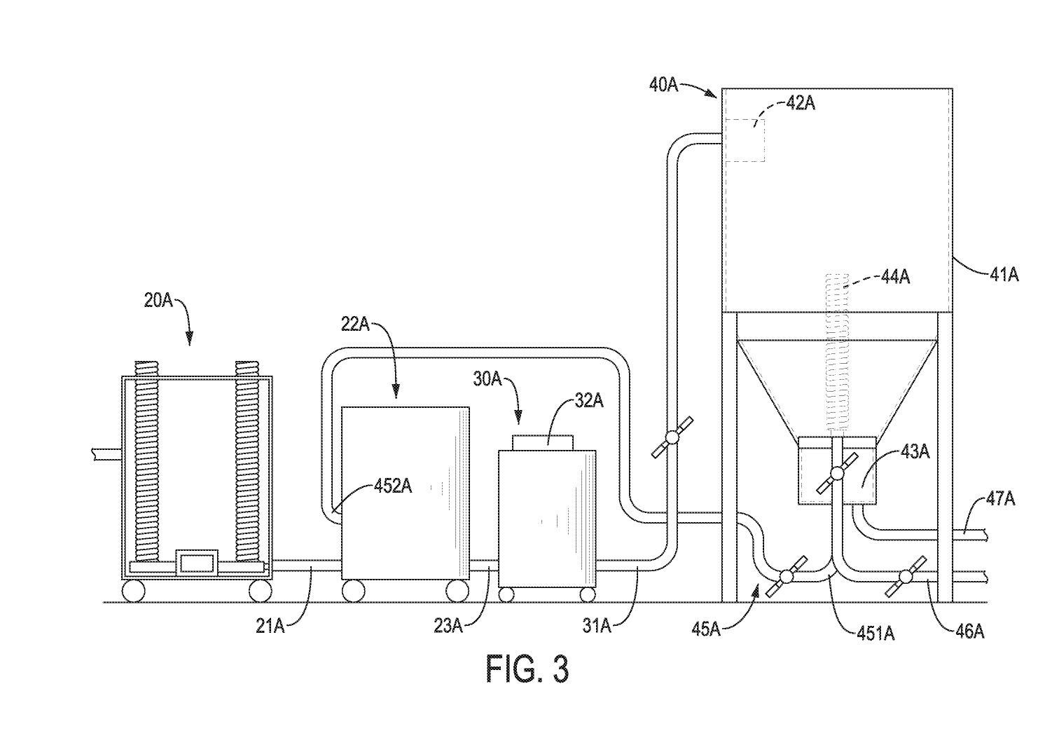

With reference to FIG. 3, a second embodiment of a sewage purifying apparatus in accordance with the present invention is substantially the same as the first embodiment except for the following features. The coarse filter 20A further has a temperature adjuster 22A disposed between the coarse filter 20A and the second pump 30A. The temperature adjuster 22A is connected to and communicates with the coarse filter 20A via the second outlet pipe 21A, and has a linking pipe 23A. The linking pipe 23A is disposed on the temperature adjuster 22A opposite to the second outlet pipe 21A, and is connected to and communicates with the second pump 30A. In use, the temperature adjuster 22A can be used to adjust the temperature of the sewage that flows out of the coarse filter 20A. If the impurities in the sewage are solidified at a low temperature, the temperature adjuster 22A may lower down the temperature of the sewage. On the contrary, if the impurities in the sewage are solidified at a high temperature, the temperature adjuster 22A may raise the temperature of the sewage.

The first centrifugal filter 40A is connected to and communicates with the second pump 30A via the third outlet pipe 31A, and has a water bucket 41A, a vortex generator 42A, a collecting box 43A, a filtering spring 44A, a return pipe 45A, a water outlet pipe 46A, and a discharging pipe 47A. The water bucket 41A may be funnel-shaped, is connected to and communicates with the third outlet pipe 31A of the second pump 30A, and has an opening disposed on a bottom of the water bucket 41A. The vortex generator 42A is disposed in the water bucket 41A corresponding to a connecting position of the third outlet pipe 31A relative to the water bucket 41A.

The collecting box 43A is disposed on the opening of the water bucket 41A to collect the residue deposited in the water bucket 41A. The filtering spring 44A is disposed in the water bucket 41A above the collecting box 43A. The return pipe 45A is connected to and communicates with the filtering spring 44A and the temperature adjuster 22A, and has an export end 451A and a return inlet end 452A. The export end 451A of the return pipe 45A is connected to and communicates with the filtering spring 44A. The return inlet end 452A of the return pipe 45A is connected to and communicates with the temperature adjuster 22A. The water outlet pipe 46A is connected to and communicates with the filtering spring 44A. The discharging pipe 47A is connected to and communicates with the collecting box 43A.

Furthermore, the first centrifugal filter 40 and the second centrifugal filter 60 in the first embodiment of the sewage purifying apparatus may have the same structures as the first centrifugal filter 40A in the second embodiment of the sewage purifying apparatus.

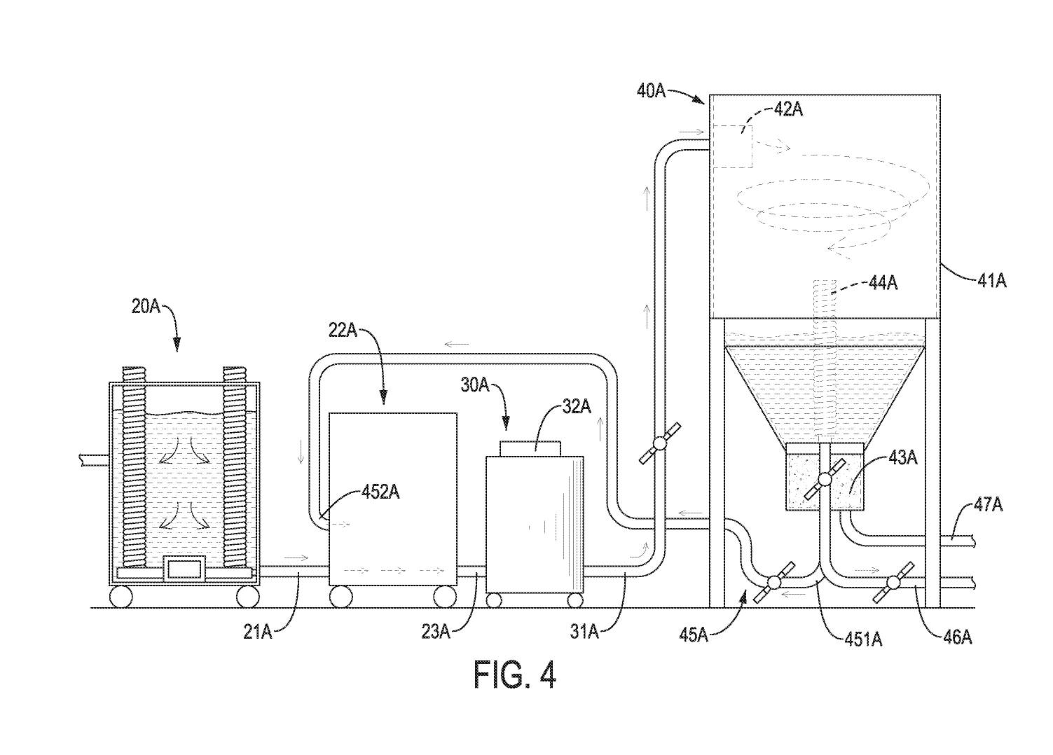

With reference to FIGS. 3 and 4, when the second embodiment of the sewage purifying apparatus of the present invention is in use, the sewage from a sewage tank is filtered by the coarse filter 20A to filter the impurities of large size (or large particles) out of the sewage, and the sewage without the impurities of large size flows in the temperature adjuster 22A via the second outlet pipe 21A. The temperature adjuster 22A can be adjusted (increase or reduce) to change the temperature of the sewage to solidify the impurities from the sewage. After the temperature adjustment, the sewage is drawn by the second pump 30A and is sterilized by the oxygenation device 32A when the ozone is dissolved in the sewage.

The sewage after sterilization flows in the first centrifugal filter 40A, the sewage may be rotated by a vortex that is generated by the vortex generator 42A, and the impurities and water are separated by a centrifugal force of the first centrifugal filter 40A, and the impurities and particles are disposed in the bottom of the water bucket 41A and are collected in the collecting box 43A. If the filtered condition of the water does not meet the requirement, the water flows in the return pipe 45A through the filtration of the filtering spring 44A and returns to the temperature adjuster 22A to repeat the aforementioned processes, and this may provide a circulating filtering effect. If the filtering condition of the water meets the requirement, the water discharges out of the first centrifugal filter 40A via the water outlet pipe 46A. Furthermore, the impurities and particles that are collected in the collecting box 43A can be discharged out of the first centrifugal filter 40A via the discharging pipe 47A.

In the second embodiment of the sewage purifying apparatus of the present invention, the temperature adjuster 22A may provide a solidification effect to the impurities and particles in the sewage to enable the impurities and particles to deposit in the collecting box 43A of the first centrifugal filter 40A, and the first centrifugal filter 40A may separate the impurities and water to improve the filtering effect to the sewage.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A sewage purifying apparatus comprising:
a first pump for drawing liquid;
a coarse filter connected to and communicating with the first pump to filter the liquid;
a second pump connected to and communicating with the coarse filter to draw the liquid after the coarse filter;
a first centrifugal filter connected to and communicating with the second pump to filter the liquid after the second pump;
a third pump connected to and communicating with the first centrifugal filter to draw the liquid after the first centrifugal filter;
a second centrifugal filter connected to and communicating with the third pump to filter the liquid after the third pump;
a fourth pump connected to and communicating with the second centrifugal filter to draw the liquid after the second centrifugal filter;
a secondary filter connected to and communicating with the fourth pump, and having multiple filtering elements to filter the liquid that flows out of the fourth pump sequentially; and
a storage tank connected to and communicating with the secondary filter to store the liquid after the secondary filter.

2. The sewage purifying apparatus as claimed in claim 1, wherein the coarse filter is a spring filter.

3. The sewage purifying apparatus as claimed in claim 2, wherein the second pump has an oxygenation device disposed on the second pump to provide ozone to sterilize the liquid in the second pump.

4. The sewage purifying apparatus as claimed in claim 3, wherein the multiple filtering elements of the secondary filter are respectively a first filtering element, a second filtering element, and a third filtering element.

5. The sewage purifying apparatus as claimed in claim 4, wherein the first filtering element is activated carbon, the second filtering element is resin, and the third filtering element is ceramics.

6. The sewage purifying apparatus as claimed in claim 5, wherein each one of the first pump, the second pump, the third pump, and the fourth pump is a gear pump.

7. The sewage purifying apparatus as claimed in claim 1, wherein the coarse filter has a temperature adjuster disposed between the coarse filter and the second pump to provide a temperature-adjusting effect to the liquid that flows in the temperature adjuster.

8. The sewage purifying apparatus as claimed in claim 2, wherein the coarse filter has a temperature adjuster disposed between the coarse filter and the second pump to provide a temperature-adjusting effect to the liquid that flows in the temperature adjuster.

9. The sewage purifying apparatus as claimed in claim 3, wherein the coarse filter has a temperature adjuster disposed between the coarse filter and the second pump to provide a temperature-adjusting effect to the liquid that flows in the temperature adjuster.

10. The sewage purifying apparatus as claimed in claim 4, wherein the coarse filter has a temperature adjuster disposed between the coarse filter and the second pump to provide a temperature-adjusting effect to the liquid that flows in the temperature adjuster.

11. The sewage purifying apparatus as claimed in claim 5, wherein the coarse filter has a temperature adjuster disposed between the coarse filter and the second pump to provide a temperature-adjusting effect to the liquid that flows in the temperature adjuster.

12. The sewage purifying apparatus as claimed in claim 6, wherein the coarse filter has a temperature adjuster disposed between the coarse filter and the second pump to provide a temperature-adjusting effect to the liquid that flows in the temperature adjuster.

13. The sewage purifying apparatus as claimed in claim 7, wherein the first centrifugal filter has
a water bucket connected to and communicating with the second pump and having an opening disposed on a bottom of the water bucket;
a vortex generator disposed in the water bucket;
a collecting box disposed on the opening of the water bucket;
a filtering spring disposed in the water bucket above the collecting box; and
a discharging pipe connected to and communicating with the collecting box.

14. The sewage purifying apparatus as claimed in claim 8, wherein the first centrifugal filter has
a water bucket connected to and communicating with the second pump and having an opening disposed on a bottom of the water bucket;
a vortex generator disposed in the water bucket;
a collecting box disposed on the opening of the water bucket;
a filtering spring disposed in the water bucket above the collecting box; and
a discharging pipe connected to and communicating with the collecting box.

15. The sewage purifying apparatus as claimed in claim 9, wherein the first centrifugal filter has
a water bucket connected to and communicating with the second pump and having an opening disposed on a bottom of the water bucket;
a vortex generator disposed in the water bucket;
a collecting box disposed on the opening of the water bucket;
a filtering spring disposed in the water bucket above the collecting box; and
a discharging pipe connected to and communicating with the collecting box.

16. The sewage purifying apparatus as claimed in claim 10, wherein the first centrifugal filter has
a water bucket connected to and communicating with the second pump and having an opening disposed on a bottom of the water bucket;
a vortex generator disposed in the water bucket;
a collecting box disposed on the opening of the water bucket;
a filtering spring disposed in the water bucket above the collecting box; and
a discharging pipe connected to and communicating with the collecting box.

17. The sewage purifying apparatus as claimed in claim 11, wherein the first centrifugal filter has
a water bucket connected to and communicating with the second pump and having an opening disposed on a bottom of the water bucket;
a vortex generator disposed in the water bucket;
a collecting box disposed on the opening of the water bucket;
a filtering spring disposed in the water bucket above the collecting box; and
a discharging pipe connected to and communicating with the collecting box.

18. The sewage purifying apparatus as claimed in claim 12, wherein the first centrifugal filter has
a water bucket connected to and communicating with the second pump and having an opening disposed on a bottom of the water bucket;
a vortex generator disposed in the water bucket;
a collecting box disposed on the opening of the water bucket;
a filtering spring disposed in the water bucket above the collecting box; and
a discharging pipe connected to and communicating with the collecting box.
